(19) United States
(12) Patent Application Publication
(10) Pub. No.: US 2025/0206993 A1
(43) Pub. Date: Jun. 26, 2025

(54) ENERGY-RAY-CROSSLINKABLE ADHESIVE AGENT COMPOSITION, CROSSLINKED ADHESIVE AGENT, ADHESIVE SHEET, AND PRODUCTION METHODS THEREFOR

(71) Applicant: LINTEC CORPORATION, Tokyo (JP)

(72) Inventors: Kenta YAMAZAKI, Saitama-shi (JP); Shinya SUZUKI, Toda-shi (JP)

(73) Assignee: LINTEC CORPORATION, Tokyo (JP)

(21) Appl. No.: 18/850,865

(22) PCT Filed: Mar. 31, 2022
(86) PCT No.: PCT/JP2022/016669

§ 371 Date: Sep. 25, 2024

(51) Int. Cl. C09J 7/38; C08J 3/20; C08K 5/07; C09J 133/04

(52) U.S. Cl. CPC C09J 7/385; C08J 3/203; C08K 5/07; C09J 133/04; C08J 2333/06; C09J 2301/302; C09J 2301/416; C09J 2433/00

(57) ABSTRACT

An energy-ray-crosslinkable pressure-sensitive adhesive composition containing an acrylic polymer having energy ray crosslinkability, and another acrylic polymer that is substantially free of radical-reactive unsaturated double bonds and has a weight-average molecular weight (Mw) of 280000 or less. The energy-ray-crosslinkable pressure-sensitive adhesive composition is included in a pressure-sensitive adhesive sheet and a crosslinked pressure-sensitive adhesive obtained by crosslinking the energy-ray-crosslinkable pressure-sensitive adhesive composition with an energy ray. A method for producing the crosslinked pressure-sensitive adhesive, a method for producing the crosslinked pressure-sensitive adhesive, and a method for producing the pressure-sensitive adhesive sheet are also provided.

### TECHNICAL FIELD

The present invention relates to an energy-ray-crosslinkable pressure-sensitive adhesive composition, a crosslinked pressure-sensitive adhesive, a pressure-sensitive adhesive sheet, and methods for producing these.

### BACKGROUND ART

Pressure-sensitive adhesive sheets are used in a wide range of industrial fields, for example, label applications for displaying various types of information; applications for fixing or temporarily fixing various components in fields such as office automation equipment, household electrical appliances, automobiles, and construction; and masking applications.

Hot-melt pressure-sensitive adhesives are widely used as pressure-sensitive adhesives for pressure-sensitive adhesive sheets. Hot-melt pressure-sensitive adhesives can be applied to base materials and the like by heating and melting without using a solvent and thus have an advantage of reducing an environmental impact when producing pressure-sensitive adhesive sheets.

As hot-melt pressure-sensitive adhesives, for example, synthetic rubber-based hot-melt pressure-sensitive adhesives are widely known. In recent years, acrylic hot-melt pressure-sensitive adhesives and the like have been developed in response to a growing need to reduce environmental impact.

For example, Patent Document 1 discloses a radiation-curable hot-melt pressure-sensitive adhesive containing 100 parts by weight of an acrylic polymer having a radiation-reactive group, 3 to 20 parts by weight. of an acrylic monomer, and 0.002 to 0.2 parts by weight of a polymerization inhibitor having a specific structure.

### CITATION LIST

### Patent Literature

Patent Document 1: JP 2015-214601 A

### SUMMARY OF INVENTION

### Technical Problem

The radiation-curable hot-melt pressure-sensitive adhesive in Patent Document 1 contains the acrylic monomer as an essential component in order to form a crosslinked structure between acrylic polymers having radiation-reactive groups and to improve the cohesive strength of the radiation-curable hot-melt pressure-sensitive adhesive after irradiation with radiation. It is also disclosed that a polyfunctional acrylic monomer is preferably used as the acrylic monomer.

However, when the hot-melt pressure-sensitive adhesive contains a monomer having such a radical-reactive unsaturated double bond or a polymer such as an oligomer or a polymer, heating causes a polymerization reaction, which increases the viscosity of the hot-melt pressure-sensitive adhesive over time, causing a decrease in coating properties and gel formation. As a result, a usage period of the hot-melt pressure-sensitive adhesive, that is, a so-called “pot life”, is shortened. In addition, since the hot-melt pressure-sensitive adhesive is used as a pressure-sensitive adhesive layer of a pressure-sensitive adhesive sheet by a method of coating a base material or the like by heating and melting the hot-melt pressure-sensitive adhesive, good coating properties are also required during the coating.

The present invention has been completed in consideration of the above problems, and an object of the present invention is to provide an energy-ray-crosslinkable pressure-sensitive adhesive composition that can form a pressure-sensitive adhesive having a long pot life and excellent coating properties; a pressure-sensitive adhesive sheet containing the energy-ray-crosslinkable pressure-sensitive adhesive composition and a production method thereof; a crosslinked pressure-sensitive adhesive obtained by crosslinking the energy-ray-crosslinkable pressure-sensitive adhesive composition using an energy ray and a production method thereof; and a pressure-sensitive adhesive sheet containing the crosslinked pressure-sensitive adhesive and a production method thereof.

### Solution to Problem

The inventors have found that the above problems can be solved by using an acrylic resin having energy ray crosslinkability and a specific acrylic polymer, and have thus completed the present invention.

That is, the present invention relates to [1] to [13] below.
[1] An energy-ray-crosslinkable pressure-sensitive adhesive composition including a component (A) being an acrylic polymer having energy ray crosslinkability and a component (B) being an acrylic polymer other than the component (A), in which the component (B) is substantially free of radical-reactive unsaturated double bonds and has a weight-average molecular weight (Mw) of 280000 or less.
[2] The energy-ray-crosslinkable pressure-sensitive adhesive composition according to [1], in which the component (A) is an acrylic polymer having a benzophenone structure in a side chain.
[3] The energy-ray-crosslinkable pressure-sensitive adhesive composition according to [1] or [2], in which a content of the component (B) is 50 parts by mass or less relative to 100 parts by mass of the component (A).
[4] The energy-ray-crosslinkable pressure-sensitive adhesive composition according to any one of [1] to [3], including a component (C) being a hydrogen abstraction type photoinitiator.
[5] The energy-ray-crosslinkable pressure-sensitive adhesive composition according to any one of [1] to [4], including a component (D) being a tackifier.
[6] The energy-ray-crosslinkable pressure-sensitive adhesive composition according to any one of [1] to [5], in which a content of the component (A) is from 50 to 98 mass % when a total amount of the pressure-sensitive adhesive composition is 100 mass %.
[7] A pressure-sensitive adhesive sheet including an energy-ray-crosslinkable pressure-sensitive adhesive composition layer on a base material or a release liner, in which the energy-ray-crosslinkable pressure-sensitive adhesive composition layer is composed of the energy-ray-crosslinkable pressure-sensitive adhesive composition according to any one of [1] to [6].
[8] A method for producing a pressure-sensitive adhesive sheet including an energy-ray-crosslinkable pressure-sensitive adhesive composition layer, the method including:
(11) obtaining an energy-ray-crosslinkable pressure-sensitive adhesive composition by melt-kneading a component (A) being an acrylic polymer having energy ray crosslinkability and a component (B) being an acrylic polymer other than the component (A), in which the component (B) is substantially free of radical-reactive unsaturated double bonds and has a weight-average molecular weight (Mw) of 280000 or less, and
(12) forming the energy-ray-crosslinkable pressure-sensitive adhesive composition layer by melting and applying the energy-ray-crosslinkable pressure-sensitive adhesive composition on a base material or a release liner.
[9] A crosslinked pressure-sensitive adhesive obtained by irradiating the energy-ray-crosslinkable pressure-sensitive adhesive composition according to any one of [1] to [6] with an energy ray.
[10] A method for producing the crosslinked pressure-sensitive adhesive according to [9], the method including irradiating the energy-ray-crosslinkable pressure-sensitive adhesive composition with an energy ray.
[11] A pressure-sensitive adhesive sheet including a pressure-sensitive adhesive layer on a base material or a release liner, in which the pressure-sensitive adhesive layer is composed of the crosslinked pressure-sensitive adhesive according to [9] or [10].
[12] A method for producing a pressure-sensitive adhesive sheet, including:
(22) forming, on a base material or a release liner, an energy-ray-crosslinkable pressure-sensitive adhesive composition layer including an energy-ray-crosslinkable pressure-sensitive adhesive composition containing a component (A) being an acrylic polymer having energy ray crosslinkability and a component (B) being an acrylic polymer other than the component (A), in which the component (B) is substantially free of radical-reactive unsaturated double bonds and has a weight-average molecular weight (Mw) of 280000 or less, and
(23) forming a pressure-sensitive adhesive layer composed of a crosslinked pressure-sensitive adhesive by irradiating the energy-ray-crosslinkable pressure-sensitive adhesive composition layer with an energy ray.
[13] The method for producing a pressure-sensitive adhesive sheet according to [12], the method including step (21) obtaining an energy-ray-crosslinkable pressure-sensitive adhesive composition by melt-kneading a component (A) being an acrylic polymer having energy ray crosslinkability and a component (B) being an acrylic polymer other than the component (A) before step (22), in which the component (B) is substantially free of radical-reactive unsaturated double bonds and has a weight-average molecular weight (Mw) of 280000 or less, and further in step (22), the energy-ray-crosslinkable pressure-sensitive adhesive composition layer is formed by melting and applying the energy-ray-crosslinkable pressure-sensitive adhesive composition obtained through step (21) on the base material or the release liner.

### Advantageous Effects of Invention

According to the present invention, an energy-ray-crosslinkable pressure-sensitive adhesive composition that can form a pressure-sensitive adhesive having a long pot life and excellent coating properties; a pressure-sensitive adhesive sheet containing the energy-ray-crosslinkable pressure-sensitive adhesive composition and a production method thereof, a crosslinked pressure-sensitive adhesive obtained by crosslinking the energy-ray-crosslinkable pressure-sensitive adhesive composition using an energy ray and a production method thereof, and a pressure-sensitive adhesive sheet containing the crosslinked pressure-sensitive adhesive and a production method thereof can be provided.

### BRIEF DESCRIPTION OF DRAWINGS

FIG. 1 is a schematic cross-sectional view illustrating an example of a configuration of a pressure-sensitive adhesive sheet according to the present invention.

FIG. 2 is a schematic cross-sectional view illustrating another example of a configuration of a pressure-sensitive adhesive sheet according to the present invention.

FIG. 3 is a schematic cross-sectional view illustrating another example of a configuration of a pressure-sensitive adhesive sheet according to the present invention.

### DESCRIPTION OF EMBODIMENTS

In the present specification, the lower and upper limits of a preferable numerical range (for example, a range of content) described in series can each be independently combined. For example, from the description “preferably from 10 to 90, more preferably from 30 to 60”, the “preferred lower limit (10)” and the “more preferred upper limit (60)” can be combined as “from 10 to 60”. A similar combination may also be applied to, for example, “preferably 10 or more, more preferably 30 or more, and preferably 90 or less, and more preferably 60 or less”.

In the present specification, the “energy ray” means an electromagnetic wave or a charged particle beam having an energy quantum, and examples include ultraviolet rays, radiation, and electron beams. The ultraviolet rays can be irradiated by using, for example, an electrodeless lamp, a high-pressure mercury lamp, a metal halide lamp, or a UV-LED as an ultraviolet ray source. The electron beam can be generated by an electron beam accelerator or the like and irradiated. Note that the energy ray in an embodiment of the present invention is preferably an ultraviolet ray among those described above.

In the present specification, “energy-ray-crosslinkable” refers to a property of forming a crosslinked structure by irradiation with an energy ray.

In the present specification, the term “(meth)acrylic” is used as a term meaning either “acrylic” or “methacrylic” or both. Similarly, the term “(meth)acrylate” is used as a term meaning either “acrylate” or “methacrylate” or both. Similarly, the term “(meth)acryloyl” is used as a term meaning either “acryloyl” or “methacryloyl” or both.

In addition, in the present specification, “weight-average molecular weight (Mw)” is a value measured by a gel permeation chromatography (GPC) method based on the standard polystyrene, and specifically is a value measured based on a method described in Examples.

Further, the mechanism of action described in the present specification is speculation and does not limit the mechanism by which the effects of the present invention are achieved.

### Energy-Ray-Crosslinkable Pressure-Sensitive Adhesive Composition

An energy-ray-crosslinkable pressure-sensitive adhesive composition according to one embodiment of the present invention is an energy-ray-crosslinkable pressure-sensitive adhesive composition containing (A) an acrylic polymer having energy ray crosslinkability (hereinafter also simply referred to as “component (A)”) and (B) an acrylic polymer other than component (A) that is substantially free of radical-reactive unsaturated double bonds and has a weight-average molecular weight (Mw) of 280000 or less (hereinafter also simply referred to as “component (B)”).

The energy-ray-crosslinkable pressure-sensitive adhesive composition (hereinafter, also simply referred to as “pressure-sensitive adhesive composition”) forms a crosslinked structure by being irradiated with an energy ray to form a crosslinked pressure-sensitive adhesive. That is, the pressure-sensitive adhesive composition is a composition that is intended to be irradiated with an energy ray before or after being attached to an adherend.

The pressure-sensitive adhesive composition can be irradiated with an energy ray at any time. Thus, the pressure-sensitive adhesive composition can be produced and used with high flexibility.

Specifically, because no intentional crosslinked structure is formed in the pressure-sensitive adhesive composition, the pressure-sensitive adhesive composition can be heated and melted and is therefore suitable as a hot-melt pressure-sensitive adhesive.

Furthermore, the pressure-sensitive adhesive composition has no intentional crosslinked structure formed in it and thus has excellent shape conformability. Thus, the pressure-sensitive adhesive composition can be suitably used in applications in which the pressure-sensitive adhesive composition is attached to an adherend having a step or the like, and then a crosslinked pressure-sensitive adhesive is formed by energy ray irradiation.

Each component contained in the pressure-sensitive adhesive composition will be described in detail below.

### (A) Acrylic Polymer Having Energy Ray Crosslinkability

Component (A) is not limited as long as it is an acrylic polymer having energy ray crosslinkability. One type of component (A) may be used alone, or a combination of two or more types of components (A) may be used.

Examples of component (A) include acrylic polymers having energy-ray-reactive groups that react upon irradiation with an energy ray and contribute to formation of a crosslinked structure.

Examples of the energy-ray-reactive group include groups that are excited by irradiation with energy rays to generate radicals that trigger a crosslinking reaction.

Specific examples of the energy-ray-reactive group include functional groups having a benzophenone structure, a benzyl structure, an o-benzoylbenzoic acid ester structure, a thioxanthone structure, a 3-ketocoumarin structure, a 2-ethylanthraquinone structure, and a camphorquinone structure. Among these, (A) an acrylic polymer having energy ray crosslinkability preferably has a benzophenone structure in a side chain.

When component (A) has a benzophenone structure, for example, upon irradiation with an energy ray, the benzophenone structure draws a hydrogen atom from a hydrocarbon group contained in a side chain of the acrylic polymer, and the resulting radicals recombine to form a crosslinked structure.

Note that from the viewpoint of facilitating the formation of the crosslinked structure, the energy-ray-reactive group is preferably incorporated into a side chain of the acrylic polymer. That is, component (A) is preferably an acrylic polymer having a benzophenone structure in a side chain.

The content of the energy-ray-reactive group in component (A) is preferably from 0.02 to 5.0 mass % and more preferably from 0.05 to 3.0 mass % relative to the total amount (100 mass %) of component (A).

The energy-ray-reactive group may be incorporated into component (A), for example, by copolymerizing a monomer having a functional group, such as a vinyl group, capable of reacting with an acrylic monomer and having the energy-ray-reactive group with the acrylic monomer. Alternatively, for example, the energy-ray-reactive group may be incorporated by reacting a compound having the energy-ray-reactive group with a side chain of the acrylic polymer by a known method.

The acrylic polymer is not limited as long as it is a polymer containing an acrylic monomer as a monomer component and has energy ray crosslinkability, but it preferably contains a constitutional unit derived from an alkyl (meth)acrylate.

Examples of the alkyl (meth)acrylate include methyl (meth)acrylate, ethyl (meth)acrylate, n-propyl (meth)acrylate, n-butyl (meth)acrylate, isobutyl (meth)acrylate, sec-butyl (meth)acrylate, n-hexyl(meth)acrylate, 2-ethylhexyl (meth)acrylate, n-octyl (meth)acrylate, isooctyl (meth)acrylate, n-nonyl(meth)acrylate, isononyl (meth)acrylate, n-decyl(meth)acrylate, and lauryl (meth)acrylate. Among these, alkyl (meth)acrylate with an alkyl group having one or more and eight or less carbon atoms is preferable, and 2-ethylhexyl (meth)acrylate, methyl (meth)acrylate, or butyl (meth)acrylate is more preferable.

One type of these alkyl (meth)acrylates may be used alone, or a combination of two or more types of these alkyl (meth)acrylates may be used.

In component (A), the content of the constitutional unit derived from alkyl (meth)acrylate in all constitutional units (100 mass %) of component (A) is preferably from 80 to 100 mass %, more preferably from 90 to 100 mass %, even more preferably from 95 to 100 mass %, and still more preferably from 98 to 100 mass %.

In the present specification, the content of a constitutional unit of a monomer relative to all constitutional units (100 mass %) of component (A) can also be regarded as the content of monomer when the total amount of monomers blended in synthesizing component (A) is 100 mass %.

Unless otherwise specified, all constitutional units (100 mass %) of component (A) do not include, for example, constitutional units derived from a polymerization initiator, a chain transfer agent, and a compound having an energy-ray-reactive group used in polymerization of the polymer.

The constitutional units derived from monomers constituting the acrylic polymer may contain constitutional units derived from monomers other than the alkyl (meth)acrylate, as necessary. Examples of the monomers other than the alkyl (meth)acrylate that can be used in component (A) include monomers other than monomer (b1) described below in the section for component (B).

A weight-average molecular weight (Mw) of component (A) is not limited as long as the effects of the present invention are achieved, but is preferably 10000 or more, more preferably 50000 or more, even more preferably 100000 or more, and is preferably 500000 or less, more preferably 400000 or less, even more preferably 300000 or less.

The content of component (A) in the pressure-sensitive adhesive composition may be from 50 to 98 mass %, from 60 to 97 mass %, or from 70 to 96 mass %, when the total amount of the pressure-sensitive adhesive composition is 100 mass %.

### (B) Acrylic Polymer Other Than Component (A), That Is Substantially Free of Radical-Reactive Unsaturated Double Bonds and Has Weight-Average Molecular Weight (Mw) of 280000 or Less

Component (B) is an acrylic polymer other than component (A), and is not limited as long as it is substantially free of radical-reactive unsaturated double bonds, and is an acrylic resin having a weight-average molecular weight (Mw) of 280000 or less. One type of component (B) may be used alone, or a combination of two or more types of components (B) may be used.

When the pressure-sensitive adhesive composition contains component (B), the pressure-sensitive adhesive performance can be improved.

Since component (B) is substantially free of radical-reactive unsaturated double bonds, when the pressure-sensitive adhesive composition is heated, a polymerization reaction of component (B) is prevented or suppressed, making it possible to suppress an increase in the viscosity of the pressure-sensitive adhesive composition over time. As a result, a pot life of the pressure-sensitive adhesive composition can be extended.

The “radical-reactive unsaturated double bonds” mean unsaturated double bonds capable of being involved in a radical reaction by heating or energy irradiation, and include both unsaturated double bonds that generate active sites of the radical reaction by reacting with radicals generated from a component other than component (B), such as an initiator, and unsaturated double bonds that themselves are activated by heating or energy irradiation to generate radicals to initiate a reaction.

Examples of the radical-reactive unsaturated double bonds include radical-reactive carbon-carbon double bonds. Examples of functional groups containing the radical-reactive carbon-carbon double bonds include a (meth)acryloyl group, a vinyl group, and an allyl group.

Component (B) “is substantially free of radical-reactive unsaturated double bonds” means, for example, that the content of constitutional units derived from monomers having radical-reactive unsaturated double bonds even after polymerization in all the constitutional units (100 mass %) of component (B) is preferably 1.0 mass % or less, more preferably 0.1 mass % or less, and still more preferably 0.05 mass % or less.

In the present specification, the content of a constitutional unit of a monomer relative to all constitutional units (100 mass %) of component (B) can also be regarded as the content of monomer when the total amount of monomers blended in synthesizing component (B) is 100 mass %.

Unless otherwise specified, all constitutional units (100 mass %) of component (B) do not include, for example, constitutional units derived from a polymerization initiator and a chain transfer agent used in polymerization of the polymer.

When the weight-average molecular weight (Mw) of component (B) exceeds 280000, the viscosity of the pressure-sensitive adhesive composition increases and the coating properties become poor. Therefore, from the viewpoint of suppressing a decrease in the coating properties of the pressure-sensitive adhesive composition, the weight-average molecular weight (Mw) of component (B) is preferably 260000 or less, more preferably 240000 or less, and even more preferably 220000 or less. The weight-average molecular weight (Mw) of component (B) is preferably 1000 or more, more preferably 5000 or more, and even more preferably 10000 or more.

Component (B) is not limited as long as it satisfies the requirements described above and is a polymer containing an acrylic monomer as a monomer component, but it preferably contains a constitutional unit derived from an alkyl (meth)acrylate (b1).

As the alkyl (meth)acrylate (b1) (hereinafter, also referred to as “monomer (b1)”) that can be used in component (B), for example, an alkyl (meth)acrylate with an alkyl group having 1 to 18 carbon atoms is preferably used. Specific examples include methyl (meth)acrylate, ethyl (meth)acrylate, propyl (meth)acrylate, n-butyl (meth)acrylate, isobutyl (meth)acrylate, sec-butyl (meth)acrylate, tert-butyl (meth)acrylate, n-pentyl(meth)acrylate, n-hexyl(meth)acrylate, 2-ethylhexyl (meth)acrylate, isooctyl (meth)acrylate, n-decyl(meth)acrylate, n-dodecyl (meth)acrylate, n-tridecyl(meth)acrylate, myristyl(meth)acrylate, palmityl(meth)acrylate, and stearyl (meth)acrylate.

One type of monomer (b1) may be used alone, or a combination of two or more types of monomers (b1) may be used.

As monomer (b1), among the monomers described above, an alkyl (meth)acrylate with an alkyl group having 1 to 8 carbon atoms is more preferable.

From the viewpoint of improving compatibility with component (A), the content of the constitutional unit derived from monomer (b1) in component (B) is preferably from 60 to 100 mass %, more preferably from 80 to 100 mass %, even more preferably from 90 to 100 mass %, and still more preferably from 95 to 100 mass % in all constitutional units (100 mass %) of component (B).

Alternatively, component (B) may be an acrylic copolymer that contains, in addition to the constitutional unit derived from monomer (b1), constitutional units derived from monomers other than monomer (b1).

Examples of monomers other than monomer (b1) include functional group-containing monomers that do not have two or more radical-reactive unsaturated double bonds in the molecule; (meth)acrylates having a cyclic structure that do not have two or more radical-reactive unsaturated double bonds; vinyl acetates; and styrene.

The monomers other than monomer (b1) may be used alone, or in combination of two or more.

Examples of the functional group-containing monomers that do not have two or more radical-reactive unsaturated double bonds in the molecule include monomers having functional groups such as a carboxy group, a hydroxy group, an epoxy group, an amino group, a cyano group, a nitrogen atom-containing cyclic group, and an alkoxysilyl group.

Examples of the carboxy group-containing monomer include ethylenically unsaturated carboxylic acids having only one radical-reactive unsaturated double bond, such as (meth)acrylic acid, crotonic acid, maleic acid, fumaric acid, itaconic acid, and citraconic acid.

Examples of the hydroxy group-containing monomer include hydroxyalkyl (meth)acrylates, such as 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate; and unsaturated alcohols having only one radical-reactive unsaturated double bond, such as vinyl alcohol and allyl alcohol.

Examples of the (meth)acrylates having a cyclic structure that do not have two or more radical-reactive unsaturated double bonds in the molecule include cyclohexyl (meth)acrylate, benzyl (meth)acrylate, and isobornyl (meth)acrylate.

When component (B) contains a constitutional unit derived from a monomer other than monomer (b1), the content of a constitutional unit derived from a monomer other than monomer (b1) in component (B) is preferably from 0.5 to 40 mass %, more preferably from 1 to 20 mass %, even more preferably from 2 to 10 mass %, and still further preferably from 3 to 5 mass %, relative to all constitutional units (100 mass %) of component (B).

When component (B) contains, in addition to the constitutional unit derived from monomer (b1), a constitutional unit derived from a monomer other than monomer (b1), the total content of the constitutional units derived from monomer (b1) and the constitutional unit derived from a monomer other than monomer (b1) in component (B) may be 100 mass % relative to all constitutional units (100 mass %) of component (B).

When component (B) is an acrylic copolymer containing constitutional units derived from a plurality of monomers (b1); or an acrylic copolymer containing a constitutional unit derived from a single monomer (b1) or constitutional units of a plurality of monomers (b1) and a constitutional unit derived from a monomer other than the constitutional unit derived from the single monomer (b1) or the constitutional units of the plurality of monomers (b1), the form of copolymerization is not limited and may be a block copolymer or a random copolymer.

The content of component (B) in the pressure-sensitive adhesive composition is preferably 50 parts by mass or less relative to 100 parts by mass of component (A), and from the viewpoint of suppressing a decrease in the cohesive strength of a pressure-sensitive adhesive obtained from the pressure-sensitive adhesive composition and suppressing fouling of an adherend to which the pressure-sensitive adhesive is attached, is more preferably 45 parts by mass or less, and even more preferably 40 parts by mass or less. From the viewpoint of pressure-sensitive adhesive performance, a lower limit of the content of component (B) in the pressure-sensitive adhesive composition is preferably 3 parts by mass or more, more preferably 5 parts by mass or more, and even more preferably 10 parts by mass or more.

From the viewpoint of making it easier to achieve the effects of the present invention, the total content of component (A) and component (B) is preferably 60 mass % or more, more preferably 70 mass % or more, and even more preferably 80 mass % or more, and 100 mass % or less, when the total amount of the pressure-sensitive adhesive composition is 100 mass %.

### (C) Hydrogen Abstraction Type Photoinitiator

The pressure-sensitive adhesive composition may further contain (C) a hydrogen abstraction type photoinitiator (hereinafter, also simply referred to as “component (C)”).

Component (C) has a function of generating radicals. The generated radicals abstract hydrogen atoms bonded to carbon atoms of a main chain skeleton or the like in component (A) and/or component (B), thereby generating radicals in the acrylic polymer and directly crosslinking components (A) to each other, components (B) to each other, or component (A) to component (B).

Examples of component (C) include aromatic ketones such as acetophenone, benzophenone, P,P′-dimethoxybenzophenone, 4-methylbenzophenone, P,P′-dichlorobenzophenone, P,P′-dimethylbenzophenone, and acetonaphthone. Other examples include aromatic aldehydes such as terephthalaldehyde, and quinone aromatic compounds such as methylanthraquinone. Among these, from the viewpoint of ease of radical generation, a compound containing benzophenone is preferably used.

One type of component (C) may be used alone, or a combination of two or more types of components (C) may be used.

When the pressure-sensitive adhesive composition contains component (C), the content of component (C) in the pressure-sensitive adhesive composition is, relative to 100 parts by mass that is the total of component (A) and component (B), preferably 0.1 parts by mass or more, more preferably 0.2 parts by mass or more, even more preferably 0.3 parts by mass or more, and preferably 3.0 parts by mass or less, more preferably 2.0 parts by mass or less, even more preferably 1.0 parts by mass or less.

### (D) Tackifier

The pressure-sensitive adhesive composition may further contain (D) a tackifier (hereinafter also simply referred to as “component (D)”).

Component (D) is a component capable of improving the pressure-sensitive adhesive properties of the resulting crosslinked pressure-sensitive adhesive, and is not limited as long as the effects of the present invention are achieved.

Examples of component (D) include rosin-based resins such as polymerized rosins, polymerized rosin esters, and rosin derivatives, and hydrogenated products thereof (hydrogenated rosin-based resins); terpene-based resins such as polyterpene resins, aromatic-modified terpene resins, and terpene phenolic resins, and hydrogenated products thereof (hydrogenated terpene-based resins); coumarone-indene resins; petroleum resins such as aliphatic petroleum resins, aromatic petroleum resins, and aliphatic/aromatic copolymer petroleum resins, and hydrogenated products thereof (hydrogenated petroleum resins); styrene or substituted styrene polymers; and styrene resins such as α-methylstyrene homopolymer resins, copolymers of α-methylstyrene and styrene, copolymers of styrene monomers and aliphatic hydrocarbon monomers, copolymers of styrene, α-methylstyrene, and aliphatic hydrocarbon monomers, homopolymers composed of styrene monomers, and copolymers of styrene monomers and aromatic monomers, and hydrogenated products thereof (hydrogenated styrene resins).

One type of component (D) may be used alone, or a combination of two or more types of components (D) may be used.

The softening point of component (D) is preferably from 70 to 140° C., more preferably from 80 to 135° C., and even more preferably from 85 to 130° C.

When the softening point of component (D) is 70° C. or higher, excellent adhesive strength tends to be obtained at high temperatures. When the softening point of component (D) is 140° C. or lower, it tends to be easily mixed with (A) an energy-ray-crosslinkable acrylic resin.

Note that in the present specification, the softening point of component (D) refers to a value measured in accordance with JIS K 5601-2-2:1999.

When the pressure-sensitive adhesive composition contains component (D), the content of component (D) is preferably from 5 to 35 parts by mass, more preferably from 10 to 30 parts by mass, and even more preferably from 15 to 25 parts by mass, relative to 100 parts by mass of component (A).

When the pressure-sensitive adhesive composition contains component (D) with a content of 5 parts by mass or more, component (D) tends to facilitate further improvement of the adhesive strength. With a content of 40 parts by mass or less, component (D) tends to facilitate further improvement of holding power.

### Other Components

The pressure-sensitive adhesive composition may or may not contain components other than the components described above, as long as the effects of the present invention are achieved.

Examples of the other components include softening agents; antioxidants; and additives used in a common pressure-sensitive adhesive.

For each of these other components, one type may be used alone, or two or more types may be used in combination.

The antioxidant is not limited, and any known antioxidant can be used. Examples of the antioxidants include hindered phenol-based antioxidants, sulfur-based antioxidants, and phosphorus-based antioxidants.

Examples of the additives used in a common pressure-sensitive adhesive include wax, filler, extenders, thermal stabilizers, light stabilizers, ultraviolet absorbers, colorants (such as pigments and dyes), flame retardants, antistatic agents, stringiness retarders, antioxidants, inorganic particles, organic particles, and weight-reducing agents.

For each of these additives for pressure-sensitive adhesives, one type may be used alone, or two or more types may be used in combination.

When these other components are contained, the content of each of the other components is independently preferably from 0.0001 to 20 parts by mass, and more preferably from 0.001 to 10 parts by mass, relative to 100 parts by mass that is the total of component (A) and component (B).

From the viewpoint of more easily achieving the effects of the present invention, it is preferable that the pressure-sensitive adhesive composition be substantially free of compounds having radical-reactive unsaturated double bonds, such as a polyfunctional acrylate. Here, the pressure-sensitive adhesive composition “is substantially free of compounds having radical-reactive unsaturated double bonds” means, for example, that the content of the compound having a radical-reactive unsaturated double bond when the total amount of the pressure-sensitive adhesive composition is 100 mass % is preferably 1.0 mass % or less, more preferably 0.1 mass % or less, and even more preferably 0.05 mass % or less.

From the viewpoint of reducing environmental impact, it is preferable that the pressure-sensitive adhesive composition be substantially free of solvent, and it is more preferable that it be solvent-free. Here, the pressure-sensitive adhesive composition is “substantially free of solvent” means, for example, that the content of the solvent is preferably 0.5 mass % or less, more preferably 0.1 mass % or less, when the total amount of the pressure-sensitive adhesive composition is 100 mass %.

When the pressure-sensitive adhesive composition further contains, in addition to component (A) and component (B), one or more components selected from component (C), component (D), and the other components described above, the total content of component (A) and component (B) and one or more components selected from component (C), component (D) and the other components described above, is preferably 60 mass % or more, more preferably 70 mass % or more, even more preferably 80 mass % or more, and 100 mass % or less, when the total amount of the pressure-sensitive adhesive composition is 100 mass %.

### Method for Producing Pressure-Sensitive Adhesive Composition

The pressure-sensitive adhesive composition can be produced, for example, by a method of melt-kneading (A) an acrylic resin having energy ray crosslinkability, (B) an acrylic polymer that is substantially free of radical-reactive unsaturated double bonds and in which a weight-average molecular weight (Mw) of component (B) is 280000 or less, and any optional components used as necessary.

Note that in the following description, a step of melt-kneading component (A), component (B), and other components may be referred to as a “melt-kneading step”.

The melt-kneading step is, for example, a step of feeding the components into a mixing device equipped with a heating device, such as a heated kneader, and mixing the components in a molten state.

Examples of the mixing device equipped with a heating device include a single-screw extruder, a twin screw extruder, a roll mill, a Banbury mixer, an intermix, and a pressure kneader.

In a case where a mixing device that can reduce pressure is used, as necessary, the pressure in the inside of the mixing device may be reduced, and the melt-kneading may be performed under reduced pressure.

The kneading temperature in the melt-kneading step is not particularly limited, and a temperature condition under which the components are sufficiently mixed in a melted state is to be appropriately selected. The kneading temperature is preferably from 80 to 180° C., more preferably from 100 to 170° C., and even more preferably from 120 to 150° C.

Note that when the pressure-sensitive adhesive composition is produced by melt-kneading, the pressure-sensitive adhesive composition does not need to contain a solvent. From the viewpoint of reducing an environmental impact, it is preferable that the pressure-sensitive adhesive composition be substantially free of solvent, and it is more preferable that the pressure-sensitive adhesive composition be solvent-free. Here, the pressure-sensitive adhesive composition is “substantially free of solvent” means, for example, that the content of the solvent is preferably 0.5 mass % or less, more preferably 0.1 mass % or less, when the total amount of the pressure-sensitive adhesive composition is 100 mass %.

The pressure-sensitive adhesive composition obtained after melt-kneading may be applied, in a heated and molten state, onto a base material or a release liner using an extruder or the like and used to produce a pressure-sensitive adhesive sheet, which is one embodiment of the present invention, as described later, or, as desired, may be filled into various containers or the like without going through a forming step, for example.

### Crosslinked Pressure-Sensitive Adhesive

The crosslinked pressure-sensitive adhesive according to one embodiment of the present invention is a crosslinked pressure-sensitive adhesive obtained by irradiating the energy-ray-crosslinkable pressure-sensitive adhesive composition according to one embodiment of the present invention with an energy ray.

That is, the crosslinked pressure-sensitive adhesive has a crosslinked structure formed by an energy ray crosslinking reaction of (A) an energy-ray-crosslinkable acrylic resin contained in the energy-ray-crosslinkable pressure-sensitive adhesive composition.

The crosslinked pressure-sensitive adhesive itself also has good adhesive strength and can also exhibit excellent adhesive strength to an adherend. For example, from the viewpoint of eliminating a need for an energy ray irradiation step after adhesion to an adherend, the pressure-sensitive adhesive composition may be irradiated with an energy ray before adhesion to the adherend to form the crosslinked pressure-sensitive adhesive, and the crosslinked pressure-sensitive adhesive may then be attached to the adherend as a crosslinked pressure-sensitive adhesive.

The crosslinked pressure-sensitive adhesive can be produced by a method of irradiating the energy-ray-crosslinkable pressure-sensitive adhesive composition with an energy ray.

That is, a method for producing the crosslinked pressure-sensitive adhesive has a step of irradiating the energy-ray-crosslinkable pressure-sensitive adhesive composition with an energy ray.

Note that in the following description, the step of irradiating the energy-ray-crosslinkable pressure-sensitive adhesive composition with an energy ray may be referred to as “energy ray irradiation step”.

### Pressure-Sensitive Adhesive Sheet

One embodiment of the present invention can provide a first pressure-sensitive adhesive sheet and a second pressure-sensitive adhesive sheet described below.

The first pressure-sensitive adhesive sheet is a pressure-sensitive adhesive sheet including, on a base material or a release liner, an energy-ray-crosslinkable pressure-sensitive adhesive composition layer composed of the energy-ray-crosslinkable pressure-sensitive adhesive composition.

The second pressure-sensitive adhesive sheet is a pressure-sensitive adhesive sheet including, on a base material or a release liner, a pressure-sensitive adhesive layer composed of the crosslinked pressure-sensitive adhesive.

In the following description, the “energy-ray-crosslinkable pressure-sensitive adhesive composition layer composed of the energy-ray-crosslinkable pressure-sensitive adhesive composition” included in the first pressure-sensitive adhesive sheet is also simply referred to as “pressure-sensitive adhesive composition layer”.

The “pressure-sensitive adhesive layer composed of the crosslinked pressure-sensitive adhesive” included in the second pressure-sensitive adhesive sheet is also simply referred to as “pressure-sensitive adhesive layer”.

When simply referring to the “pressure-sensitive adhesive sheet”, both the first pressure-sensitive adhesive sheet and the second pressure-sensitive adhesive sheet are meant.

Some examples of configurations of the pressure-sensitive adhesive sheet according to one embodiment of the present invention will be described with reference to the accompanying drawings, but the present invention is not limited to the following examples.

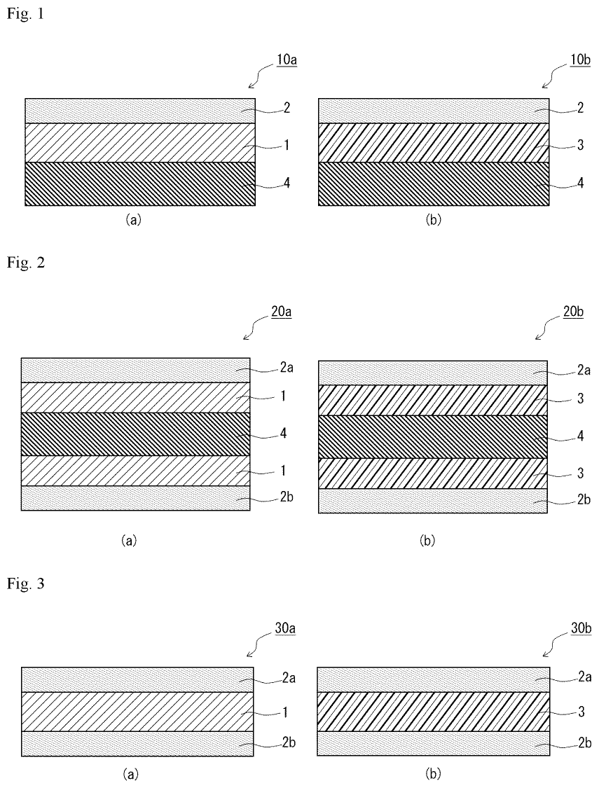

FIG. 1(a) illustrates, as an example of the first pressure-sensitive adhesive sheet, a pressure-sensitive adhesive sheet 10a having: a release liner 2 on one surface side of a pressure-sensitive adhesive composition layer 1; and a base material 4 on the other surface side of the pressure-sensitive adhesive composition layer 1.

In addition, FIG. 1(b) illustrates, as an example of the second pressure-sensitive adhesive sheet, a pressure-sensitive adhesive sheet 10b having: the release liner 2 on one surface side of a pressure-sensitive adhesive layer 3; and the base material 4 on the other surface side of the pressure-sensitive adhesive layer 3.

The pressure-sensitive adhesive sheets 10a and 10b are suitable for applications in which, for example, the release liner 2 is peeled off and removed and then the exposed surface of the pressure-sensitive adhesive composition layer 1 or the pressure-sensitive adhesive layer 3 is applied to an adherend. Examples of such use include use for a label.

Note that when the pressure-sensitive adhesive sheet to be attached to an adherend is the first pressure-sensitive adhesive sheet, the pressure-sensitive adhesive composition layer is attached to the adherend and then irradiated with an energy ray to form a pressure-sensitive adhesive layer composed of the crosslinked pressure-sensitive adhesive.

FIG. 2(a) illustrates, as another example of the first pressure-sensitive adhesive sheet, a double-sided pressure-sensitive adhesive sheet 20a having: pressure-sensitive adhesive composition layers 1 on both surfaces of the base material 4; a release liner 2a on a surface of one pressure-sensitive adhesive composition layer 1, the surface being on the opposite side to the base material 4; and a release liner 2b on a surface of the other pressure-sensitive adhesive composition layer 1, the surface being on the opposite side to the base material 4.

In addition, FIG. 2(b) illustrates, as another example of the second pressure-sensitive adhesive sheet, a double-sided pressure-sensitive adhesive sheet 20b having: the pressure-sensitive adhesive layers 3 on both surfaces of the base material 4; the release liner 2a on a surface of one pressure-sensitive adhesive layer 3, the surface being on the opposite side to the base material 4; and the release liner 2b on a surface of the other pressure-sensitive adhesive layer 3, the surface being on the opposite side to the base material 4.

FIG. 3(a) illustrates, as another example of the first pressure-sensitive adhesive sheet, a base-material-less pressure-sensitive adhesive sheet 30a having the release liners 2a and 2b on both sides of the pressure-sensitive adhesive composition layer 1.

FIG. 3(b) illustrates, as another example of the second pressure-sensitive adhesive sheet, a base-material-less pressure-sensitive adhesive sheet 30b having the release liners 2a and 2b on both surfaces of the pressure-sensitive adhesive layer 3.

The pressure-sensitive adhesive sheets 20a, 20b, 30a, and 30b are suitable for bonding adherends together, in which, for example, the release liner 2a on one surface side is peeled off and removed, then the exposed surface of the pressure-sensitive adhesive composition layer 1 or the pressure-sensitive adhesive layer 3 is applied to an adherend, then the release liner 2b is further peeled off and removed, and then the exposed surface of the pressure-sensitive adhesive composition layer 1 or the pressure-sensitive adhesive layer 3 is applied to another adherend. Examples of such applications include applications for fixing or temporarily fixing various components.

In the pressure-sensitive adhesive sheets 30a and 30b, in the case where the peeling force for peeling off the release liner 2a from the pressure-sensitive adhesive composition layer 1 or the pressure-sensitive adhesive layer 3 is approximately the same as the peeling force for peeling off the release liner 2b from the pressure-sensitive adhesive composition layer 1 or the pressure-sensitive adhesive layer 3, an attempt to peel off both release liners by pulling them outward may result in a phenomenon where the pressure-sensitive adhesive composition layer 1 or the pressure-sensitive adhesive layer 3 is divided along with the two release liners and peeled off. From the viewpoint of suppressing such a phenomenon, two release liners designed to have different peeling forces are preferably used as the two release liners 2a and 2b.

The thickness of the pressure-sensitive adhesive composition layer in the first pressure-sensitive adhesive sheet and the thickness of the pressure-sensitive adhesive layer in the second pressure-sensitive adhesive sheet are each independently preferably from 5 to 100 μm, more preferably from 10 to 60 μm, and even more preferably from 15 to 30 m.

With a thickness of 5 μm or greater, the pressure-sensitive adhesive composition layer and the pressure-sensitive adhesive layer tend to facilitate further improvement of the adhesive strength. Furthermore, when the thickness of the pressure-sensitive adhesive composition layer or the pressure-sensitive adhesive layer is 100 μm or less, even better handleability tends to be achieved.

### Base Material

Examples of a material forming the base material include resins, metals, and paper materials.

Examples of the resin include a polyolefin resin such as polyethylene and polypropylene; a vinyl-based resin such as polyvinyl chloride, polyvinylidene chloride, polyvinyl alcohol, an ethylene-vinyl acetate copolymer, and an ethylene-vinyl alcohol copolymer; a polyester-based resin such as polyethylene terephthalate, polybutylene terephthalate, and polyethylene naphthalate; polystyrene; an acrylonitrile-butadiene-styrene copolymer; cellulose triacetate; polycarbonate; a urethane resin such as polyurethane and acrylic-modified polyurethane; polymethylpentene; polysulfone; polyether ether ketone; polyethersulfone; polyphenylene sulfide; a polyimide-based resin such as polyetherimide and polyimide; a polyamide-based resin; an acrylic resin; and a fluororesin.

Examples of the metal include aluminum, tin, chromium, and titanium.

Examples of the paper material include tissue paper, wood containing paper, wood-free paper, impregnated paper, coat paper, art paper, vegetable parchment, and glassine paper.

Among these materials, one type may be used alone, or two or more types may be used in combination to form the base material.

Examples of the base material in which two or more formation materials are used in combination include a material obtained by laminating a paper material with a thermoplastic resin such as polyethylene, and a material obtained by forming a metal film on a surface of a resin film or sheet containing a resin. Note that examples of a method of forming a metal layer include a method of subjecting the metal described above to vapor deposition by a PVD method, such as vacuum deposition, sputtering, or ion plating; or a method of attaching a metal foil made of the metal described above using a typical pressure-sensitive adhesive.

Note that, from the viewpoint of improving interlayer adhesion of the base material and another layer to be laminated, when the base material contains a resin, a surface of the base material may be subjected to surface treatment by an oxidation method, a roughening method, or the like, or primer treatment.

According to the application of the pressure-sensitive adhesive sheet, the base material may have, for example, a print receptive layer; a recording layer for enabling recording, such as thermal transfer recording and ink-jet recording; an overcoat film or an overlaminate film for protecting these surfaces; and/or an information region, such as a magnetic recording, a bar code, or a micro semiconductor device.

On the other hand, when the pressure-sensitive adhesive sheet is formed as a transparent pressure-sensitive adhesive sheet with transparency, the base material preferably has transparency.

The base material may contain an additive for a base material as necessary. Examples of the additive for a base material include an ultraviolet absorber, a light stabilizer, an antioxidant, an antistatic agent, a slip agent, an antiblocking agent, and a colorant. Note that for each of these additives for a base material, one type may be used alone, or two or more types may be used in combination.

The thickness of the base material is preferably from 5 to 1000 μm, more preferably from 15 to 500 μm, and even more preferably from 20 to 200 μm.

When the thickness of the base material is 5 μm or greater, the deformation resistance of the pressure-sensitive adhesive sheet tends to be improved. On the other hand, with a thickness of 1000 μm or less, the base material tends to facilitate the improvement of the handling properties of the pressure-sensitive adhesive sheet.

Note that the “thickness of the base material” means the thickness of the entire base material and, in a case where the base material contains a plurality of layers, means the total thickness of all the layers constituting the base material.

### Release Liner

For the release liner, a release liner subjected to double-sided release treatment, a release liner subjected to single-sided release treatment, or the like is used. Examples include a release liner obtained by applying a release agent on a base material for a release liner.

Examples of the base material for a release liner include paper, such as wood-free paper, glassine paper, and kraft paper; and plastic films, such as polyester resin films of a poly(ethylene terephthalate) resin, a poly(butylene terephthalate) resin, a poly(ethylene naphthalate) resin, or the like, and polyolefin resin films of a polypropylene resin, a polyethylene resin, or the like.

Examples of the release agent include a rubber-based elastomer, such as a silicone-based resin, an olefin-based resin, an isoprene-based resin, and a butadiene-based resin; a long-chain alkyl-based resin; an alkyd-based resin; and a fluorine-based resin.

The thickness of the release liner is not limited, but the thickness is preferably from 10 to 200 μm, more preferably from 20 to 180 μm, and even more preferably from 30 to 150 μm.

### Method for Producing First Pressure-Sensitive Adhesive Sheet

Examples of a method for producing the first pressure-sensitive adhesive sheet include a method for producing a pressure-sensitive adhesive sheet including steps 11 and 12 below.
Step 11: A step of obtaining an energy-ray-crosslinkable pressure-sensitive adhesive composition by melt-kneading (A) an acrylic resin having energy ray crosslinkability and (B) an acrylic polymer that is substantially free of radical-reactive unsaturated double bonds and in which the weight-average molecular weight (Mw) of component (B) is 280000 or less
Step 12: A step of forming the energy-ray-crosslinkable pressure-sensitive adhesive composition layer by melting and applying the energy-ray-crosslinkable pressure-sensitive adhesive composition on a base material or a release liner

Note that in the present specification, “on a release liner” refers to “on a release-treated surface” of a release liner subjected to release treatment on one side.

The description of step 11 is the same as the description of the melt-kneading step in the method for producing the energy-ray-crosslinkable pressure-sensitive adhesive composition according to one embodiment of the present invention. Similarly, in step 11, in addition to components (A) and (B), optional components used as necessary, for example, component (C), component (D), and other components may be melt-kneaded to obtain a pressure-sensitive adhesive composition. Component (A), component (B), the base material, the release liner, and component (C), component (D), and the other components, that may be used as necessary, used in the method for producing the first pressure-sensitive adhesive sheet are each similar to those described in the section of the energy-ray-crosslinkable pressure-sensitive adhesive composition, and preferred embodiments thereof are also similar.

Step 12 may be a method of forming a pressure-sensitive adhesive composition layer by applying the energy-ray-crosslinkable pressure-sensitive adhesive composition obtained through step 11, while it is in a heated and molten state, onto a base material or a release liner using an extruder, a T-die, and the like. Thereafter, as necessary, a step of cooling the pressure-sensitive adhesive composition layer may be included.

The pressure-sensitive adhesive composition layer can be formed on the base material or the release liner through step 12.

The sheet with the base material or the release liner and the pressure-sensitive adhesive composition layer may be used as is as the first pressure-sensitive adhesive sheet, which is one embodiment of the present invention, or may be subjected to an additional step as necessary to form a desired pressure-sensitive adhesive sheet.

For example, a pressure-sensitive adhesive sheet having a release liner on one surface side of a pressure-sensitive adhesive composition layer and having a base material on the other surface side of the pressure-sensitive adhesive composition layer as in the pressure-sensitive adhesive sheet 10a illustrated in FIG. 1(a) can be produced by applying the release-treated surface of the release liner to the exposed surface of the pressure-sensitive adhesive composition layer formed on the base material.

In addition, a double-sided pressure-sensitive adhesive sheet having pressure-sensitive adhesive composition layers on both surfaces of a base material and having a release liner on the surface of each pressure-sensitive adhesive composition layer, the surface being on the opposite side to the base material, as in the pressure-sensitive adhesive sheet 20a illustrated in FIG. 2(a) can be produced by applying the base material surface of the pressure-sensitive adhesive sheet 10a to the exposed surface of the pressure-sensitive adhesive composition layer formed on the release liner.

Alternatively, a base material-less pressure-sensitive adhesive sheet having release liners on both surfaces of the pressure-sensitive adhesive composition layer as in the pressure-sensitive adhesive sheet 30a illustrated in FIG. 3(a) can be produced by applying the release-treated surface of one release liner to the exposed surface of the pressure-sensitive adhesive composition layer formed on another release liner.

### Method for Producing Second Pressure-Sensitive Adhesive Sheet

Examples of a method for producing the second pressure-sensitive adhesive sheet include a method for producing a pressure-sensitive adhesive sheet including steps 22 and 23 below.
Step 22: A step of forming an energy-ray-crosslinkable pressure-sensitive adhesive composition layer, on a base material or a release liner, composed of the energy-ray-crosslinkable pressure-sensitive adhesive composition including (A) an acrylic resin having energy ray crosslinkability and (B) an acrylic polymer that is substantially free of radical-reactive unsaturated double bonds and has a weight-average molecular weight (Mw) of 280000 or less
Step 23: A step of forming a pressure-sensitive adhesive layer composed of a crosslinked pressure-sensitive adhesive by irradiating the energy-ray-crosslinkable pressure-sensitive adhesive composition layer with an energy ray

In step 22, for example, a method similar to step 12 in the method for producing the first pressure-sensitive adhesive sheet can be used, and it is preferable to use the method similar to step 12 in the method for producing the first pressure-sensitive adhesive sheet. That is, in step 22, the energy-ray-crosslinkable pressure-sensitive adhesive composition layer is preferably formed by melting and applying the energy-ray-crosslinkable pressure-sensitive adhesive composition on the base material or the release liner.

In step 23, the timing of the energy ray irradiation is not limited, and is to be appropriately determined in consideration of the method for producing the pressure-sensitive adhesive sheet, desired physical properties, and the like.

For example, in a state where one surface of the pressure-sensitive adhesive composition layer is exposed, the pressure-sensitive adhesive composition layer may be irradiated with an energy ray directly or through the base material or the release liner, or in a state where the pressure-sensitive adhesive composition layer has the base material or the release liner on one surface and the release liner on the other surface, the pressure-sensitive adhesive composition layer may be irradiated with an energy ray through the base material or the release liner.

Furthermore, the energy ray irradiation may be performed once or a plurality of times. When the energy ray irradiation is performed multiple times, for example, the first energy ray irradiation may be performed in a state where one surface of the pressure-sensitive adhesive composition layer is exposed, then the base material or the release liner is applied to the surface, and then the second energy ray irradiation may be performed through the base material or the release liner.

Alternatively, the first energy ray irradiation may be performed at any time before the application to the adherend, and the second energy ray irradiation may be performed after the application to the adherend.

The method for producing the second pressure-sensitive adhesive sheet preferably includes step 21 below before step 22. Furthermore, in step 22, it is preferable to form the energy-ray-crosslinkable pressure-sensitive adhesive composition layer by melting and applying the energy-ray-crosslinkable pressure-sensitive adhesive composition obtained through step 21 on the base material or the release liner.

Step 21: A step of obtaining an energy-ray-crosslinkable pressure-sensitive adhesive composition by melt-kneading (A) an acrylic resin having energy ray crosslinkability and (B) an acrylic polymer that is substantially free of radical-reactive unsaturated double bonds and in which a weight-average molecular weight (Mw) of component (B) is 280000 or less

Step 21 is similar to step 11 in the method for producing the first pressure-sensitive adhesive sheet, and is as described for step 11 above.

### Uses of Energy-Ray-Crosslinkable Pressure-Sensitive Adhesive Composition, Crosslinked Pressure-Sensitive Adhesive, and Pressure-Sensitive Adhesive Sheet

The energy-ray-crosslinkable pressure-sensitive adhesive composition, the crosslinked pressure-sensitive adhesive, and the pressure-sensitive adhesive sheet, which are one embodiment of the present invention, can be used for various applications.

Specific examples include label applications; applications for fixing or temporarily fixing various components; surface protection applications; sealing material applications; and decoration and display applications.

Among these, label applications and applications for fixing or temporarily fixing various components are preferred.

The pressure-sensitive adhesive sheet for label applications may be directly adhered to various products or may be attached to packaging films and packaging containers of various products, and the like. Examples of the constitutional material of the packaging film and the packaging container include an olefin-based resin such as polypropylene and polyethylene; a polyester-based resin such as polyethylene terephthalate (PET) and polylactic acid; glass, paper, and metal.

The pressure-sensitive adhesive sheet for applications for fixing or temporary fixing is suitable for fixing or temporarily fixing, for example, electronic members, optical members, automobile components, mechanism components, construction members, or decorative members.

### EXAMPLES

The present invention will be specifically described with reference to Examples below, but the present invention is not limited to the following Examples. Physical property values in Examples are values measured by the following methods.

### Weight-Average Molecular Weight (Mw)

The weight-average molecular weight (Mw) is a standard polystyrene equivalent value measured using a gel permeation chromatograph device under the following conditions.

### Measuring Instrument

Measuring device: Product name “HLC-8320GPC” manufactured by Tosoh Corporation
Detector: Differential refractometer
Columns: One “TSK guard column super H-H”, two “TSK gel super HM-H” in series, and one “TSK gel super H2000” (all manufactured by Tosoh Corporation) were used, connected in this order from the inlet side of the measurement sample.

### Measurement Conditions

Column temperature: 40° C.
Developing solvent: tetrahydrofuran
Flow rate: 1.0 mL/min

### Thickness of Each Layer

The thickness was measured at 23° C. using a constant-pressure thickness measuring instrument (model number: “PG-02J”, standard specifications: in accordance with JIS K 6783, Z 1702, and Z 1709) manufactured by Teclock Co., Ltd.

Details of the materials used in the following Examples and Comparative Example are shown below.

### Component (A): Energy-Ray-Crosslinkable Acrylic Polymer

A260UV: Acrylic polymer having a benzophenone structure in a side chain, trade name “acResin (registered trademark) A260UV” (manufactured by BASF): weight-average molecular weight (Mw) 185000

### Component (B): Acrylic Polymer Other Than Component (A), That Is Substantially Free of Radical-Reactive Unsaturated Double Bonds and Has Weight-Average Molecular Weight (Mw) of 280000 or Less

P(BA)-1: “Poly(n-butyl acrylate)”: weight-average molecular weight (Mw) 200000
P(BA)-2: “Poly(n-butyl acrylate)”: weight-average molecular weight (Mw) 100000

### Component (C): Hydrogen Abstraction Type Photoinitiator

MBP: 4-methylbenzophenone, trade name “SpeedCure (registered trademark) MBP” (manufactured by Lambson)

### Component (D): Tackifier

D-125: Rosin-based resin (polymerized rosin ester), trade name “Pencel (registered trademark) D-125” (manufactured by Arakawa Chemical Industries, Ltd.)

### Other Components

P(BA)-3: “Polybutyl acrylate”: weight-average molecular weight (Mw) 300000
SR399E: Dipentaerythritol pentaacrylate, trade name “Sartomer (registered trademark) SR399E” (manufactured by Sartomer)
CN104NS: Epoxy acrylate, trade name “Sartomer (registered trademark) CN104N S” (manufactured by Sartomer)

### Examples 1 to 7 and Comparative Examples 1 to 3

### Production of Energy-Ray-Crosslinkable Pressure-Sensitive Adhesive Composition

Components were blended according to the composition (unit: parts by mass) shown in Table 1 and kneaded at 130° C. for 20 minutes under a nitrogen purge using a heated kneader, and an energy-ray-crosslinkable pressure-sensitive adhesive composition was obtained.

### Production of First Pressure-Sensitive Adhesive Sheet

The energy-ray-crosslinkable pressure-sensitive adhesive composition obtained above was applied, while still in a heated and molten state, onto a transparent poly(ethylene terephthalate) film (thickness: 50 μm) serving as a base material using a die coater. Thus, a first pressure-sensitive adhesive sheet having an energy-ray-crosslinkable pressure-sensitive adhesive composition layer (thickness: 20 μm) composed of the energy-ray-crosslinkable pressure-sensitive adhesive composition on the base material was obtained.

### Production of Second Pressure-Sensitive Adhesive Sheet

The energy-ray-crosslinkable pressure-sensitive adhesive composition layer of the first pressure-sensitive adhesive sheet obtained above was irradiated with ultraviolet light from the exposed surface side using a high-pressure mercury lamp (manufactured by EYE GRAPHICS COMPANY) under a condition of an integrated amount of light of 60 mJ/cm² in the UV-C region. Thus, a pressure-sensitive adhesive layer (thickness: 20 μm) was formed by energy ray crosslinking the energy-ray-crosslinkable pressure-sensitive adhesive composition layer included in the first pressure-sensitive adhesive sheet. Then, a release-treated surface of a release liner (thickness: 38 μm) was bonded to the surface of the pressure-sensitive adhesive layer, the surface being on the opposite side to the base material, and a second pressure-sensitive adhesive sheet having the base material, the pressure-sensitive adhesive layer, and the release liner in this order was obtained.

### Melt Viscosity

The viscosity of the energy-ray-crosslinkable pressure-sensitive adhesive composition produced in each of Examples and Comparative Examples at 160° C. was measured 1 hour and 10 hours after the start of heating using a viscometer (manufactured by Brookfield Corporation, trade name “DV-1II ULTRA”) and a heater (manufactured by Brookfield Corporation, trade name “THERMOSEL”). The results obtained are shown in Table 1 below.

### Evaluation of Fouling of Adherend

The second pressure-sensitive adhesive sheet produced in each of Examples and Comparative Examples was cut to 25 mm×50 mm in an environment of 23° C. and 50% RH (relative humidity), to prepare two test pieces for each. The release liners of the test pieces were removed, and the exposed pressure-sensitive adhesive layers were attached to the adherends (stainless steel plates).

The test pieces attached to the adherends were then left for 7 days in an environment of 70° C., and then left for 1 day in an environment of 23° C. and 50% RH, and one of the test pieces was peeled off from the adherend by hand at a speed of approximately 300 mm/min in a 180° direction (low-speed peeling) and the other test piece was peeled off by hand at a speed of approximately 30 m/min in a 180° direction (high-speed peeling) in an environment of 23° C. and 50% RH.

Then, the state of each layer of the test piece after peeling was visually observed, and fouling of the adherend was confirmed according to the following criteria. The results obtained are shown in Table 1 below.

No fouling: Peeling occurs at an interface between the pressure-sensitive adhesive layer and the adherend, and no pressure-sensitive adhesive remains on the adherend, providing excellent releasability.

Cohesive failure: The pressure-sensitive adhesive layer broke, and residual pressure-sensitive adhesive layer was observed on the adherend.

TABLE 1

| | | | | | | | | | | | Comparative | | |
|---|---|---|---|---|---|---|---|---|---|---|---|---|---|
| | | | | Examples | | | | | | | examples | | |
| | | | Unit | 1 | 2 | 3 | 4 | 5 | 6 | 7 | 1 | 2 | 3 |
| Composition | Component | A260UV | parts | 100 | 100 | 100 | 100 | 100 | 100 | 100 | 100 | 100 | 100 |
| of pressure- | (A) | | by | | | | | | | | | | |
| sensitive | | | mass | | | | | | | | | | |
| adhesive | Component | P(BA)-1 | parts | 5 | 10 | 40 | 50 | — | 20 | 20 | — | — | — |
| composition | (B) | Mw = | by | | | | | | | | | | |
| | | 200000 | mass | | | | | | | | | | |
| | | P(BA)-2 | parts | — | — | — | — | 10 | — | — | — | — | |
| | | Mw = | by | | | | | | | | | | |
| | | 100000 | mass | | | | | | | | | | |
| | P(BA)-3 | | parts | — | — | — | — | — | — | — | — | — | 10 |
| | Mw = 300000 | | by | | | | | | | | | | |
| | | | mass | | | | | | | | | | |
| | Sartomcr SR399E | | parts | — | — | — | — | — | — | — | 10 | — | — |
| | | | by | | | | | | | | | | |
| | | | mass | | | | | | | | | | |
| | Sartomer CN104NS | | parts | — | — | — | — | — | — | — | — | 10 | — |
| | | | by | | | | | | | | | | |
| | | | mass | | | | | | | | | | |
| | Component (C): | | parts | — | — | — | — | — | 0.5 | 0.5 | 0.5 | 0.5 | — |
| | MBP | | by | | | | | | | | | | |
| | | | mass | | | | | | | | | | |
| | Component (D): | | parts | — | — | — | — | — | — | 20 | — | — | — |
| | D-125 | | by | | | | | | | | | | |
| | | | mass | | | | | | | | | | |
| Evaluation | Melt | After 1 | cP | 30000 | 28000 | 25000 | 19000 | 15200 | 23000 | 20000 | 20000 | 25000 | 42000 |
| results | viscosity | hour | | | | | | | | | | | |
| | | After 10 | cP | 30200 | 28500 | 25000 | 20000 | 15200 | 23500 | 21000 | 45000 | 48000 | 42000 |
| | | hours | | | | | | | | | | | |

| | | | | | | | | | | | |
|---|---|---|---|---|---|---|---|---|---|---|---|
| Fouling of Adherend | Low- | None | None | None | None | None | None | None | None | None | None |

| | | | | | | | | | | |
|---|---|---|---|---|---|---|---|---|---|---|
| speed | | | | | | | | | | |
| peeling | | | | | | | | | | |
| High- | None | None | None | Cohesive | None | None | None | None | None | None |
| speed | | | | failure | | | | | | |
| peeling | | | | | | | | | | |

From Table 1, it was confirmed that the pressure-sensitive adhesive compositions obtained in Examples 1 to 7 had low melt viscosities at 160° C. and excellent coating properties. The pressure-sensitive adhesive compositions obtained in Examples 1 to 7 showed no significant increase in viscosity after continuous heating at 160° C. for 10 hours, and were confirmed to be pressure-sensitive adhesive compositions with a long pot life that were sufficiently usable even after heating for 10 hours.

It was also confirmed that the second pressure-sensitive adhesive sheets obtained in Examples 1 to 3 and Examples 5 to 7 had no fouling of the adherend even when peeled off from the adherend at a low speed and at a high speed after being attached to the adherend. In Example 4, it was confirmed that when peeled off at a high speed, cohesive failure occurred, but when peeled off at a low speed, there was no fouling of the adherend.

On the other hand, the pressure-sensitive adhesive compositions obtained in Comparative Examples 1 and 2 each contained compounds having a radical-reactive unsaturated double bond instead of component (B), and therefore, the melt viscosities after continuous heating at 160° C. for 10 hours exceeded 45000 cP, and the coating properties were significantly reduced, confirming that these pressure-sensitive adhesive compositions had a short pot life.

The pressure-sensitive adhesive composition obtained in Comparative Example 3 had a weight-average molecular weight (Mw) of component (B) exceeding 280000, and therefore, had a high melt viscosity of 42000 cP after heating at 160° C. for 1 hour, and it was confirmed that coating properties were inferior to those of each of the Examples.

### REFERENCE SIGNS LIST

1 Energy-ray-crosslinkable pressure-sensitive adhesive composition layer
2, 2a, 2b Release liner
3 Pressure-sensitive adhesive layer
4 Base material
10a, 20a, 30a First pressure-sensitive adhesive sheet
10b, 20b, 30b Second pressure-sensitive adhesive sheet

1. An energy-ray-crosslinkable pressure-sensitive adhesive composition, comprising:
a component (A) being an acrylic polymer having energy ray crosslinkability; and
a component (B) being an acrylic polymer other than the component (A), wherein
the component (B) is substantially free of radical-reactive unsaturated double bonds and has a weight-average molecular weight (Mw) of 280000 or less.

2. The energy-ray-crosslinkable pressure-sensitive adhesive composition of claim 1, wherein the component (A) is an acrylic polymer having a benzophenone group in a side chain.

3. The energy-ray-crosslinkable pressure-sensitive adhesive composition according to claim 1, wherein a content of the component (B) is 50 parts by mass or less relative to 100 parts by mass of the component (A).

4. The energy-ray-crosslinkable pressure-sensitive adhesive composition of claim 1, further comprising:
a component (C) being a hydrogen abstraction type photoinitiator.

5. The energy-ray-crosslinkable pressure-sensitive adhesive composition of claim 1, further comprising:
a component (D) being a tackifier.

6. The energy-ray-crosslinkable pressure-sensitive adhesive composition of claim 1, wherein a content of the component (A) is from 50 to 98 mass % based on a total mass of the pressure-sensitive adhesive composition.

7. A pressure-sensitive adhesive sheet comprising:
an energy-ray-crosslinkable pressure-sensitive adhesive composition layer comprising the energy-ray-crosslinkable pressure-sensitive adhesive composition of claim 1; and
at least one selected from the group consisting of a base material and a release liner.

8. A method for producing a pressure-sensitive adhesive sheet including an energy-ray-crosslinkable pressure-sensitive adhesive composition layer, the method comprising:
melt-kneading a component (A) being an acrylic polymer having energy ray crosslinkability and a component (B) being an acrylic polymer other than the component (A), wherein the component (B) is substantially free of radical-reactive unsaturated double bonds and has a weight-average molecular weight (Mw) of 280000 or less to produce an energy-ray-crosslinkable pressure-sensitive adhesive composition; and
forming the energy-ray-crosslinkable pressure-sensitive adhesive composition layer by melting and applying the energy-ray-crosslinkable pressure-sensitive adhesive composition on at least one selected from the group consisting of a base material and a release liner.

9. A crosslinked pressure-sensitive adhesive obtained by irradiating the energy-ray-crosslinkable pressure-sensitive adhesive composition of claim 1 with an energy ray.

10. A method for producing the crosslinked pressure-sensitive adhesive of claim 9, the method comprising:
irradiating the energy-ray-crosslinkable pressure-sensitive adhesive composition with an energy ray.

11. A pressure-sensitive adhesive sheet comprising:
a pressure-sensitive adhesive layer on a base material or a release liner, wherein
the pressure-sensitive adhesive layer is composed of the crosslinked pressure-sensitive adhesive of claim 9.

12. A method for producing a pressure-sensitive adhesive sheet, the method comprising:
forming, on at least one selected from the group consisting of a base material and a release liner, an energy-ray-crosslinkable pressure-sensitive adhesive composition layer including an energy-ray-crosslinkable pressure-sensitive adhesive composition containing a component (A) being an acrylic polymer having energy ray crosslinkability and a component (B) being an acrylic polymer other than the component (A), in which the component (B) is substantially free of radical-reactive unsaturated double bonds and has a weight-average molecular weight (Mw) of 280000 or less; and
irradiating the energy-ray-crosslinkable pressure-sensitive adhesive composition layer with an energy ray to form a pressure-sensitive adhesive layer comprising a crosslinked pressure-sensitive adhesive.

13. The method for producing a pressure-sensitive adhesive sheet of claim 12, further comprising:
melt-kneading a component (A) being an acrylic polymer having energy ray crosslinkability and a component (B) being an acrylic polymer other than the component (A) before (22), wherein the component (B) is substantially free of radical-reactive unsaturated double bonds and has a weight-average molecular weight (Mw) of 280000 or less to produce an energy-ray-crosslinkable pressure-sensitive adhesive composition,
wherein the energy-ray-crosslinkable pressure-sensitive adhesive composition layer is formed by melting and applying the energy-ray-crosslinkable pressure-sensitive adhesive composition on the at least one selected from the group consisting of a base material and a release liner.
